(19) United States
(12) Patent Application Publication
(10) Pub. No.: US 2024/0265029 A1
(43) Pub. Date: Aug. 8, 2024

(54) INFORMATION PROCESSING APPARATUS, INFORMATION PROCESSING METHOD, AND STORAGE MEDIUM

(71) Applicant: NEC Corporation, Minato-ku, Tokyo (JP)

(72) Inventor: Genki KUSANO, Tokyo (JP)

(73) Assignee: NEC Corporation, Minato-ku, Tokyo (JP)

(21) Appl. No.: 18/566,726

(22) PCT Filed: Jun. 7, 2021
(86) PCT No.: PCT/JP2021/021639

§ 371 Date: Dec. 4, 2023

(51) Int. Cl. G06F 16/25

(52) U.S. Cl. CPC G06F 16/258

(57) ABSTRACT

To make it possible to extract similar data from across different data sets and to interpret the reason for the extraction, an information processing apparatus (1) includes: a feature calculation section (101) that calculates, with respect to data included in a second data set with which a second attribute expressed in a natural language is associated, a second feature pertaining to the second attribute; and a conversion section (102) that converts, on the basis of a relationship between a first attribute and the second attribute, the second feature into a first feature pertaining to the first attribute.

### TECHNICAL FIELD

The present invention relates to: an information processing apparatus that can be used in data analysis; and the like.

### BACKGROUND ART

It has become possible in recent years to use data from a variety of data sources, and technological development for analyzing and using such data from a variety of data sources is in progress. For example, Patent Literature 1 below discloses an information provision method which makes it possible to extract a plurality of similar users who have tastes similar to those of a user who is to be provided with information, and to allow the user who is to be provided with information to select, as an additional similar user(s), other user(s) who has/have likes and tastes similar to those of the user who is to be provided with information.

Specifically, in the information provision method of Patent Literature 1, a plurality of similar users having tastes similar to those of the user are extracted on the basis of evaluation values which the user has given on restaurants or the like and which have been registered in a database, and information of restaurants or the like highly evaluated by the similar users is provided to the user. Further, in the information provision method of Patent Literature 1, information pertaining to users who have not been extracted as similar users is also provided, so that the user can select a user to be added to the similar users.

### CITATION LIST

### Patent Literature

### Patent Literature 1

Japanese Patent Application Publication, Tokukai, No. 2020-38727

### SUMMARY OF INVENTION

### Technical Problem

The technique of Patent Literature 1 extracts similar users on the basis of information registered in a single database. As such, with the technique, in a case where a plurality of data sets exist, it is not possible to extract, from a data set different from a certain data set in which data is included, data similar to the data included in the certain data set. That is, it is not possible to extract similar data from across different data sets.

Further, in recent years, data analysis is often expected to provide interpretability of the analysis result. For example, in automatic extraction of similar data, it is expected that the reason or basis for extracting those data be interpretable or explainable.

An example object of the present invention is to provide an information processing apparatus and the like that make it possible to extract similar data from across different data sets and also make it possible to interpret and explain the reason for the extraction.

### Solution to Problem

An information processing apparatus in accordance with an example aspect of the present invention includes: a feature calculation means that calculates a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and a conversion means that converts the second feature into a first feature pertaining to the first attribute, on the basis of a relationship between the first attribute and the second attribute.

An information processing method in accordance with an example aspect of the present invention includes: calculating, by at least one processor, a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and converting, by the at least one processor, the second feature into a first feature pertaining to the first attribute, on the basis of a relationship between the first attribute and the second attribute.

A program in accordance with an example aspect of the present invention causes a computer to function as: a feature calculation means that calculates a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and a conversion means that converts the second feature into a first feature pertaining to the first attribute, on the basis of a relationship between the first attribute and the second attribute.

### Advantageous Effects of Invention

An example aspect of the present invention makes it possible to extract similar data from across different data sets and also to interpret and explain the reason for the extraction.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an information processing method in accordance with the first example embodiment of the present invention.

FIG. 3 is a block diagram illustrating a configuration of an information processing apparatus in accordance with a second example embodiment of the present invention.

FIG. 4 is a diagram illustrating a specific example of calculation of a feature.

FIG. 5 is a diagram illustrating a specific example of generation of a conversion rule.

FIG. 6 is a diagram illustrating an example of conversion of a feature with use of a matrix illustrated in FIG. 5.

FIG. 7 is a diagram illustrating an example of extraction of similar data.

FIG. 8 is a flowchart illustrating a flow of a process which the information processing apparatus carries out at a preparation stage before carrying out conversion of a feature and extraction of similar data.

FIG. 9 is a flowchart illustrating a flow of an information processing method carried out after the preparation stage.

FIG. 10 is a diagram illustrating an example of generation of a feature image in which characteristics of features of similar data are visualized.

FIG. 11 is a diagram illustrating an example of a computer which executes instructions of a program that is software realizing functions of the information processing apparatus according to each of the example embodiments of the present invention.

### EXAMPLE EMBODIMENTS

### First Example Embodiment

A first example embodiment of the present invention will be described in detail with reference to the drawings. The present example embodiment is an embodiment serving as a basis for example embodiments described later.

### (Configuration of Information Processing Apparatus)

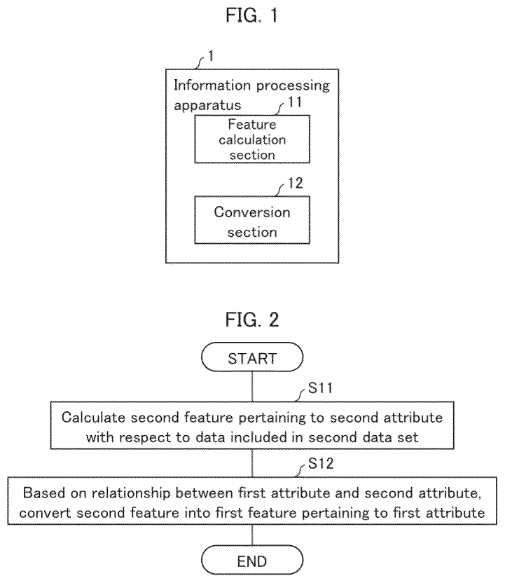

The following will discuss a configuration of an information processing apparatus 1 in accordance with the present example embodiment, with reference to FIG. 1. FIG. 1 is a block diagram illustrating a configuration of the information processing apparatus 1. As illustrated in FIG. 1, the information processing apparatus 1 includes a feature calculation section (feature calculation means) 11 and a conversion section (conversion means) 12.

The feature calculation section 11 calculates a second feature pertaining to a second attribute, with respect to data included in a second data set out of a first data set and the second data set. Note that the first data set includes a plurality of pieces of data, and a first attribute expressed in a natural language is associated with the first data set. The second data set includes at least one piece of data, and the second attribute expressed in a natural language is associated with the second data set.

On the basis of a relationship between the first attribute and the second attribute, the conversion section 12 converts the second feature calculated by the feature calculation section 11 into the first feature pertaining to the first attribute.

As described above, the information processing apparatus 1 in accordance with the present example embodiment employs a configuration of including: the feature calculation section 11 that calculates a second feature pertaining to a second attribute with respect to data included in a second data set out of (i) a first data set which includes a plurality of pieces of data and with which a first attribute expressed in a natural language is associated and (ii) the second data set which includes at least one piece of data and with which a second attribute expressed in a natural language is associated; and the conversion section 12 that converts the second feature into a first feature pertaining to the first attribute, on the basis of a relationship between the first attribute and the second attribute.

That is, according to the above configuration, for both of the data included in the first data set with which the first attribute is associated and the data included in the second data set with which the second attribute differing from the first attribute is associated, feature values can be calculated with use of a common scale, i.e., the first attribute. This makes it possible to extract, from among the plurality of pieces of data included in the first data set, data having a feature similar to that of data included in the second data set.

Further, the feature serving as a reference for the extraction is a feature pertaining to the first attribute associated with the first data set. Thus, the reason for the extraction can be explained and interpreted with use of the first attribute expressed in a natural language.

As described above, the information processing apparatus 1 in accordance with the present example embodiment provides the effect of making it possible to extract similar data from across different data sets (i.e., the first data set and the second data set) and also to explain and interpret the reason for the extraction.

### (Program)

The above-described functions of the information processing apparatus 1 can also be realized by a program. A program in accordance with the present example embodiment employs a configuration of causing a computer to function as: a feature calculation means that calculates a second feature pertaining to a second attribute with respect to data included in a second data set out of (i) a first data set which includes a plurality of pieces of data and with which a first attribute expressed in a natural language is associated and (ii) the second data set which includes at least one piece of data and with which the second attribute expressed in a natural language is associated; and a conversion means that converts the second feature into a first feature pertaining to the first attribute, on the basis of a relationship between the first attribute and the second attribute. As such, the program in accordance with the present example embodiment provides the effect of making it possible to extract similar data from across different data sets and also to interpret and explain the reason for the extraction.

### (Flow of Information Processing Method)

The following will discuss a flow of an information processing method in accordance with the present example embodiment, with reference to FIG. 2. FIG. 2 is a flowchart illustrating a flow of the information processing method. Note that steps of the information processing method may be carried out by a processor of the information processing apparatus 1 or by a processor of another apparatus. Alternatively, the steps may be carried out by processors provided in respective different apparatuses.

At S11, at least one processor calculates a second feature pertaining to a second attribute with respect to data included in a second data set out of (i) a first data set which includes a plurality of pieces of data and with which a first attribute expressed in a natural language is associated and (ii) the second data set which includes at least one piece of data and with which the second attribute expressed in a natural language is associated.

At S12, the at least one processor converts the second feature into a first feature pertaining to the first attribute, on the basis of a relationship between the first attribute and the second attribute.

As described above, the information processing method in accordance with the present example embodiment employs a configuration of including: calculating, by at least one processor, a second feature pertaining to a second attribute with respect to data included in a second data set out of (i) a first data set which includes a plurality of pieces of data and with which a first attribute expressed in a natural language is associated and (ii) the second data set which includes at least one piece of data and with which the second attribute expressed in a natural language is associated; and converting, by the at least one processor, the second feature into a first feature pertaining to the first attribute, on the basis of a relationship between the first attribute and the second attribute. As such, the information processing method in accordance with the present example embodiment provides the effect of making it possible to extract similar data from across different data sets and also to interpret and explain the reason for the extraction.

### Second Example Embodiment

The following will discuss in detail a second example embodiment of the present invention, with reference to drawings. Note that members having functions identical to those of the respective members described in the first example embodiment are given respective identical reference numerals, and a description of those members is omitted as appropriate.

### (Configuration of Information Processing Apparatus)

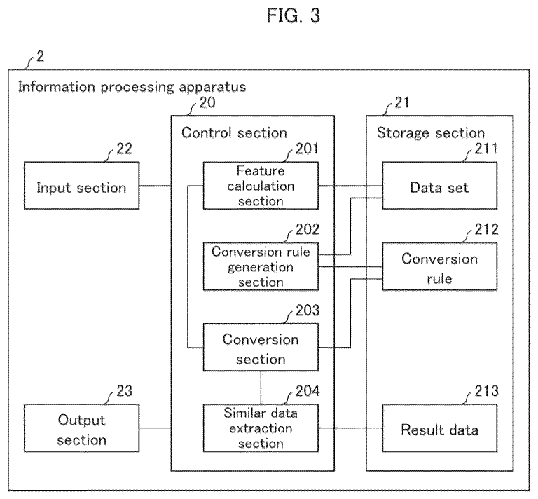

The following will discuss a configuration of an information processing apparatus 2 in accordance with the present example embodiment, with reference to FIG. 3. FIG. 3 is a block diagram illustrating a configuration of the information processing apparatus 2. As illustrated in FIG. 3, the information processing apparatus 2 includes a control section 20 which collectively controls sections of the information processing apparatus 2 and a storage section 21 in which various data used by the information processing apparatus 2 are stored. Further, the information processing apparatus 2 includes an input section 22 which receives input of various data to the information processing apparatus 2 and an output section 23 for the information processing apparatus 2 to output various data.

Further, the control section 20 includes a feature calculation section (feature calculation means) 201, a conversion rule generation section 202, a conversion section (conversion means) 203, and a similar data extraction section 204. In the storage section 21, a data set 211, a conversion rule 212, and result data 213 are stored.

The feature calculation section 201 calculates, with respect to data included in a data set with which an attribute represented in a natural language is associated, a feature pertaining to the attribute. More specifically, a first data set and a second data set are included in the data set 211 stored in the storage section 21, and the feature calculation section 201 calculates a feature with respect to data included in each of these data sets.

The first data set may be a collection of data pertaining to, for example, a single company, a single legal entity, a single group, or a single user. Further, data included in the first data set may indicate, for example, the number of products handled by the company or the like sold, the sales amount of the products, and the like. The same is true of the second data set.

It is only necessary that the attribute be associated with data included in the data set and be expressed in a natural language so that the content of the attribute can be understood by humans. For example, a category (e.g. a broad category, a medium category, and a small category) of data may be used as an attribute of the data, and in a case where the data pertains to a product or a service, a product name or a service name may be used as an attribute of the data. Further, for example, a term obtained by carrying out morphological analysis of explanatory text about a product or a service may be used as an attribute, or a product name or a summary of word-of-mouth text may be used as an attribute.

For data pertaining to a user, the attribute of the data may be the occupation, character, characteristics, or the like of the user. For example, the attribute may be “business person”, “brand lover”, “periodic purchaser”, or the like. Such attributes can also be identified from, for example, a result of a questionnaire answered by the user.

In recent years, a service called data enrichment, which assigns additional information associated with data of a data set is assigned to the data, is available. Additional information added by such a service can also be used as an attribute. The attribute of the user described above may also be identified with use of an external service, similarly as data enrichment.

On the basis of a relationship between the two attributes, the conversion rule generation section 202 generates a conversion rule for converting a feature pertaining to one attribute into a feature pertaining to the other attribute. The conversion rule generated by the conversion rule generation section 202 is stored in the storage section 21 as the conversion rule 212.

The conversion section 203 converts, on the basis of a relationship between the two attributes, a feature pertaining to one attribute into a feature pertaining to the other attribute. Specifically, the conversion section 203 carries out the conversion with use of the conversion rule 212 described above.

The similar data extraction section 204 extracts, from among the plurality of pieces of data included in the first data set, similar data similar to the data included in the second data set. As detailed later, extraction of similar data is carried out on the basis of the first feature obtained by conversion by the conversion section 203 and a feature pertaining to the first attribute about the plurality of pieces of data included in the first data set. The similar data extracted by the similar data extraction section 204 is stored in the storage section 21 as the result data 213.

The similar data extraction section 204 is not an essential configuration of the information processing apparatus 2. However, the provision of the similar data extraction section 204 is advantageous in that data similar to data included in the second data set can be automatically extracted from among the plurality of pieces of data included in the first data set. Thus, the information processing apparatus 2 preferably includes the similar data extraction section 204.

### (Specific Example of Calculation of Feature)

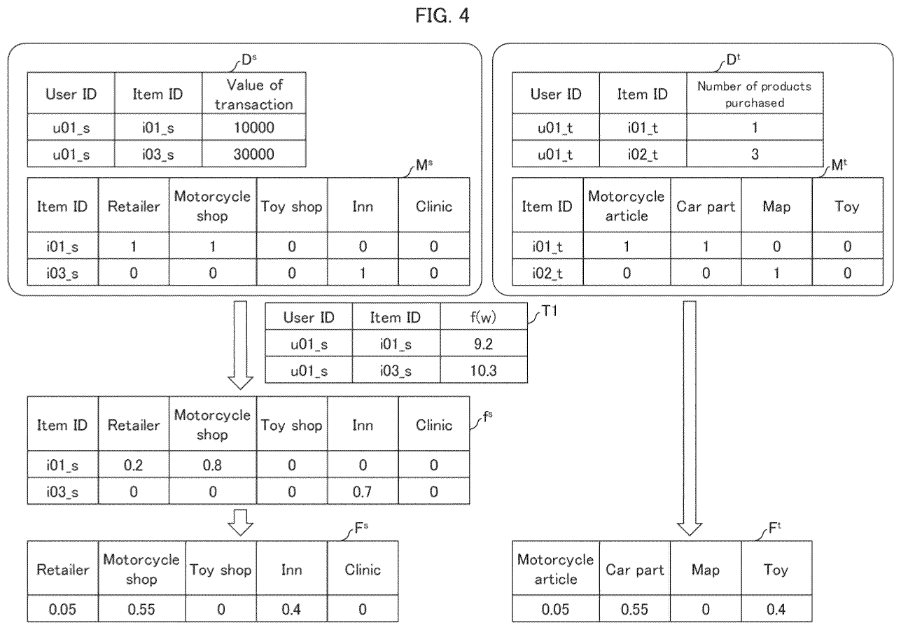

FIG. 4 is a diagram illustrating a specific example of calculation of a feature carried out by the feature calculation section 201. More specifically, FIG. 4 illustrates an example in which features are calculated from a source data set (second data set) D^{s} and a target data set (first data set) D^{t}.

The source data set D^{s} is a data set in a table format in which a user ID, an item ID, and a value of a transaction are associated with one another. This source data set D^{s} indicates a history of credit card transactions. That is, the source data set D^{s} indicates, with respect to a user identified by the user ID, a value of a credit card transaction made at a shop identified by the item ID.

Further, associated data M^{s} is data associated with the source data set D^{s} and includes a natural language representing an attribute of data included in the source data set D^{s}. Specifically, the associated data M^{s} indicates, in a natural language, categories for a shop which is identified by each item ID included in the source data set D^{s} and which has been shopped at, and also indicates, with use of a numerical value of 0 or 1, whether or not the shop falls under the categories. For example, in the associated data M^{s}, the shop having an item ID “i01_s” is given the attribute value “1” for “retailer” and “motorcycle shop” and given the attribute value “0” for the other categories. This means that the shop with the item ID “i01_s” is a retailer and a motorcycle shop and is not a toy shop, an inn, or a clinic.

The target data set D^{t} is a data set in a table format in which a user ID, an item ID, and the number of items purchased are associated with one another. This target data set D^{t} indicates a history of purchases at an online shopping site. That is, the target data set D^{t} indicates, with respect to a user identified by the user ID, the number of purchased products identified by the item ID.

Further, associated data Mt is data associated with the target data set D^{t} and includes a natural language representing an attribute of data included in the target data set D^{t}. The associated data Mt indicates, in a natural language, categories for a product identified by each item ID included in the target data set D^{t}, and also indicates, with use of a numerical value of 0 or 1, whether or not the product falls under the categories. For example, in the associated data Mt, it is indicated that the product having an item ID “i01_t” is a motorcycle article and a car part and is not a map or a toy. Note that a set of attribute names included in the associated data M^{s} will hereinafter be referred to as an attribute set A^{s}. Similarly, a set of attribute names included in the associated data Mt will be referred to as an attribute set A^{t}.

The feature calculation section 201 calculates, with respect to the data included in the source data set D^{s}, a feature pertaining to an attribute indicated in the associated data M^{s}, i.e., calculates a feature pertaining to a category for a shop at which the credit card has been used. More specifically, the feature calculation section 201 calculates, as a feature (second feature), a score indicative of a degree to which the data included in the source data set D^{s} falls under the categories for a shop at which the credit card has been used.

Specifically, the first data included in the source data set D^{s} has an item ID “i01_s” and it is indicated from the associated data M^{s} that the attribute of this item (specifically, shop) is “retailer” and “motorcycle shop”. The second data included in the source data set D^{s} has an item ID “i3_s”, and it is indicated from the associated data M^{s} that the attribute of this item is “inn”. A^{s} such, the feature calculation section 201 calculates, as features, scores indicative of degrees to which the data included in the source data set D^{s} fall under “retailer”, “motorcycle shop”, and “inn”.

Further, when calculating a feature, the feature calculation section 201 may carry out weighting in accordance with the data included in the source data set D^{s}. For example, in the source data set D^{s}, the weighting can be carried out such that the higher the value of the transaction, the higher the score. An example of such weighting is indicated in Table T1 in FIG. 4. In Table T1, f(w) represents a weighting value. The data whose value is to be used as the value of w among the plurality of data included in the source data set D^{s} can be determined in advance in accordance with the data (e.g., user or item) included in the source data set. The same is true of the function f(w), and a given function can be determined in advance in accordance with, for example, the data included in the source data set.

The above-described score can be calculated by finding a map φ^{s} in which each piece of data u included in the source data set D^{s} is converted into a vector in a dimension identical to the dimension of the associated data M^{s}. Similarly, the score of each piece of data u′ included in the target data set D^{t} can be calculated by finding a map φ^{t} in which the piece of data u′ is converted into a vector in a dimension identical to a dimension of the attribute of the associated data Mt.

Note that, a matter common between the source data set D^{s} and the target data set D^{t} may hereinafter be indicated using the superscript “Z” instead of the superscripts “s” and “t”. For example, the source data set D^{s} and the target data set D^{t} may be indicated as data set D^{Z}. The map φ^{s} and the map φ^{t} described above may be indicated as a map φ^{Z}.

The map φ^{Z} may be configured in any fashion. For example, a map φ^{Z} represented by the mathematical formula below may be used.

$${ϕ}^{z} ( u ) = h ( \{ ( f ( w ) , {g}^{z} ( i ) ) \vert ( u , i , w ) ∈ {D}^{z} \} )$$

$$where f : R \to R , {g}^{z} : {l}^{z} \to {R}^{{d}^{z}} , h : Set \to {R}^{{d}^{z}}$$

where f is a rule for converting a value and converts a real value into a real value. f may be an identity map which does not cause a change in value. For example, in a case where a value of the number of items purchased in the target data set D^{t} is w, a logarithm of w may be taken such that f(w)=log(w+1).

g^{Z} is a map in which an item is converted into a vector in a dimension of an attribute. g^{Z} can be g^{Z}=M^{Z}[i], with use of an attribute matrix in which attribute values indicated in the above-described associated data M^{s}, M^{t} are expressed in a matrix. Further, for example, a vector (e.g., g^{Z}(i)=M^{Z}_{tfidf}[i]) defined by a matrix obtained by weighting the attribute matrix with TFIDF, BM25, or the like.

h is a map in which a set is converted into a vector in an attribute dimension. A^{s} h, a map in which normalization is made so as to cause the norm to be 1 is set. For example, as indicated in the mathematical formula below, a sum of f(w)g(i) may be h, or an average or the like may be applied.

$$h ( \{ ( f ( w ) , {g}^{z} ( i ) ) \vert ( u , i , w ) ∈ {D}^{z} \} ) = {\sum }_{( u , i , w ) ∈ {D}^{z}} f ( w ) {g}^{z} ( i )$$

By carrying out the process described above, a score for each attribute is calculated for the item with each item ID, as indicated in the feature data f^{s} in FIG. 4. Then, by putting together the scores of each item with use of h, a score, i.e., a feature, as indicated in the feature data F^{s} is calculated. This feature can be expressed as a feature vector.

Further, a score, i.e., a feature, as indicated in the feature data F^{t} is calculated from the target data set D^{t} and the associated data M^{t} by a similar process. The features of data included in the target data set D^{t} can also be expressed as feature vectors.

### (Method for Generating Conversion Rule)

The conversion rule generation section 202 generates a conversion rule 212 that converts a feature pertaining to an attribute of the source data set D^{s} into a feature pertaining to an attribute of the target data set D^{t}. Note that, since the above-described features are expressed with vectors, these features will hereinafter be referred to as feature vectors.

For the conversion, a map ψ in which a feature vector φ^{s}(u) pertaining to an attribute of the source data set D^{s} is converted into a feature vector pertaining to an attribute of the target data set D^{t} may be found. For example, as shown in the mathematical formula below, a matrix product of a matrix R (described later) and φ^{s}(u) may be regarded as a map ψ(φ^{s}(u)). Rφ^{s}(u) is a feature vector (a feature in a d^{t} dimension) pertaining to an attribute of the target data set D^{t}, as indicated in the mathematical formula below.

$$ψ ( {ϕ}^{s} ( u ) ) = R {ϕ}^{s} ( u ) ∈ {R}^{{d}^{t}}$$

The matrix R may be binarized at a threshold θ to 0 and 1. In this case, ψ(φ^{s}(u)) is expressed by the mathematical formula below. By using the binarized matrix R, it is possible to emphasize the strength of the relationship between attributes. That is, in a case where the matrix R is binarized, the value of R is 1 in a case where the relationship between an attribute of the source data set D^{s} and an attribute of the target data set D^{t} is strong, and the value of R is 0 in a case where the relationship between an attribute of the source data set D^{s} and an attribute of the target data set D^{t} is weak. This makes it possible to further enhance interpretability and explicability, since the relationship between the score after the conversion and the attribute of the source data set D^{s} before the conversion is clarified.

$$ψ ( {ϕ}^{s} ( u ) ) = \hat{R} {ϕ}^{s} ( u ) ∈ {R}^{{d}^{t}} where \hat{R} [ {a}_{l}^{s} , {a}_{l}^{t} ] := \{ \begin{matrix}1 if R [ {a}_{l}^{s} , {a}_{j}^{t} ] > θ \\ 0 otherwise .\end{matrix}$$

The matrix R can be generated on the basis of a relationship between an attribute of the source data set D^{s} and an attribute of the target data set D^{t}. The conversion rule generation section 202 generates the matrix R on the basis of attributes of the source data set D^{s} and attributes of the target data set D^{t} and causes the matrix R to be stored in the storage section 21 as the conversion rule 212.

The matrix R used can be one which converts a value not more than a certain threshold θ into 0. In this case, ψ(φ^{s}(u)) is expressed by the mathematical formula below. By partitioning the matrix R by a threshold θ and converting a value not more than the threshold θ into 0, it is possible to prevent attributes with low relevance from affecting the score after conversion.

$$ψ ( {ϕ}^{s} ( u ) ) = \hat{R} {ϕ}^{s} ( u ) ∈ {R}^{{d}^{t}} where \hat{R} [ {a}_{i}^{s} , {a}_{j}^{t} ] :$$

$$= \{ \begin{matrix}R [ {a}_{i}^{s} , {a}_{j}^{t} ] if R [ {a}_{i}^{s} , {a}_{j}^{t} ] > θ \\ 0 otherwise .\end{matrix}$$

The matrix R based on a relationship between an attribute of the source data set D^{s} and an attribute of the target data set D^{t} can be generated by, for example, a similarity function, the theory of optimal transportation, or the like.

For example, the conversion rule generation section 202 may generate the matrix R on the basis of a similarity between character strings. In this case, the conversion rule generation section 202 can generate a matrix Rₛₜᵣ shown in the mathematical formula below. A^{s} the similarity between character strings, for example, Jaccard similarity, Levenshtein similarity, n-gram similarity, or the like may be applied.

$${R}_{str} [ {a}_{i}^{s} , {a}_{j}^{t} ] = StringSimilarity ( {a}_{i}^{s} , {a}_{j}^{t} )$$

Further, calculation of similarity may be carried out in a space in which attribute names are vectorized. In this case, the conversion rule generation section 202 can generate a matrix R_{emb} shown in the mathematical formula below. Note that emb(a) in the mathematical formula below is a vector obtained by applying an embedded vector in natural language processing to an attribute name a. A^{s} a method of vectorization, an embedded model in natural language processing, for example, word2vec or fasttext, may be applied. A^{s} the similarity, it is possible to apply, for example, a cosine similarity, a similarity based on an Euclidean distance, or the like.

$${R}_{emb} [ {a}_{i}^{s} , {a}_{j}^{t} ] = EmbeddingSimilarity ( emb ( {a}_{i}^{s} ) , emb ( {a}_{j}^{t} ) )$$

A^{s} described above, the conversion rule generation section 202 can generate the conversion rule 212 such that the higher a degree of similarity between an attribute of the source data set D^{S} and an attribute of the target data set D^{t}, the more significantly a score before a conversion is reflected to a score after the conversion.

According to the above configuration, the conversion rule 212 can be automatically generated. Further, since the conversion rule 212 generated is such that the higher a degree of similarity between an attribute of the source data set D^{s} and an attribute of the target data set D^{t}, the more significantly a score before a conversion is reflected to a score after the conversion, it is possible to carry out conversion reasonably in accordance with a degree of similarity between attributes.

In addition, in a case of applying the theory of optimal transport, the conversion rule generation section 202 can generate a matrix Rₒₜ represented by the mathematical formula below. Note that the mathematical formula below is different from the mathematical formula used in a general optimal transport matrix in that normalization is carried out in the column direction (j) on the right side of the first row. By this normalization, the scores of the attributes included in the attribute set A^{s} of the source data set D^{s} are allocated such that a sum of the scores equals 1 in an attribute set A^{t} of the target data set D^{t}.

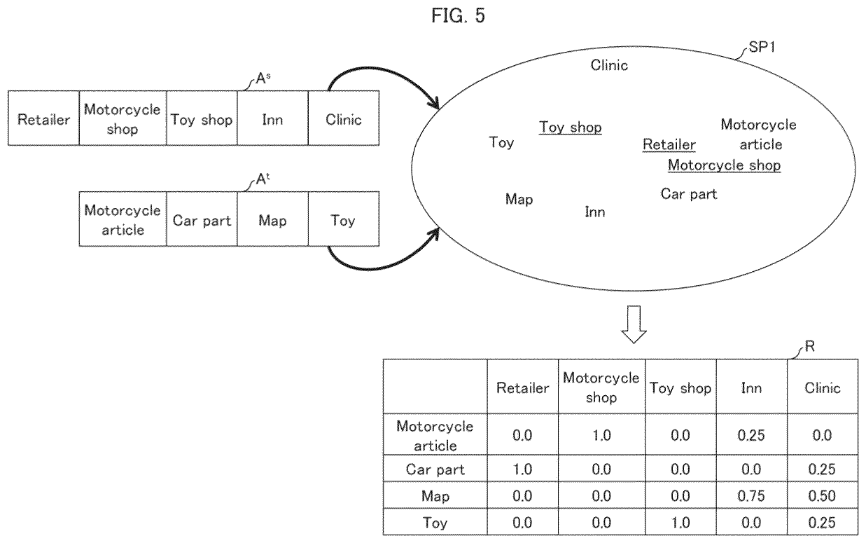

In this case, a transport matrix T that achieves mapping in accordance with similarity of words, such as Word Mover's Distance and Word Rotator's Distance, is used as the conversion rule 212. Note that an example of generation of the matrix Rₒₜ will be described later with reference to FIG. 5. Further, details of Word Mover's Distance and Word Rotator's Distance are described, for example, in the literature below.
Matt Kusner et al., “From Word Embeddings To Document Distances”, 2015, PMLR 37: 957-966
Sho Yokoi et al., “Word Rotator's Distance”, 2020, Association for Computational Linguistics, pp. 2944-2960

$${R}_{ot} [ {a}_{i}^{s} , {a}_{j}^{t} ] = T [ i , j ] / {\sum }_{{j}^{′}} T [ i , {j}^{′} ] s . t . T$$

$$= argminOptimalTransportDistance ( \{ emb ( {a}_{i}^{s} ) \} , \{ emb ( {a}_{j}^{t} ) \} ; T )$$

A^{s} described above, the conversion rule generation section 202 can generate the conversion rule 212 from the attribute of the source data set D^{s} and the attribute of the target data set D^{t} in accordance with the theory of optimal transportation.

According to the above configuration, the conversion rule can be automatically generated. Further, since the conversion rule is generated in accordance with the theory of optimal transport, the strength of the relationship between an attribute of the source data set D^{s} and an attribute of the target data set D^{t} can be emphasized. For example, it is possible to significantly reflect a score before a conversion to a score after the conversion in a case where the relationship between the attributes is strong, and to not reflect a score before a conversion to a score after the conversion in a case where the relationship between the attributes is weak. This makes it possible to further enhance interpretability and explicability, since the relationship between the score after the conversion and the attribute of the source data set D^{s} before the conversion is clarified.

A matrix in which a combination of the above-described various matrices are combined with weights may be used as a matrix R to be used in conversion. In this case, the matrix R is expressed by the mathematical formula below.

$$R = {w}_{str} * {R}_{str} + {w}_{emb} * {R}_{emb} + {w}_{ot} * {R}_{ot} ( {w}_{str} , {w}_{emb} , {w}_{ot} ∈ R )$$

### (Specific Example of Generation of Conversion Rule)

FIG. 5 is a diagram illustrating a specific example of generation of a conversion rule by the conversion rule generation section 202. More specifically, FIG. 5 illustrates an example in which the matrix R is generated from the attribute set A^{s} of the associated data M^{s} and the attribute set A^{t} of the associated data M^{t} illustrated in FIG. 4. This matrix R is generated in accordance with the theory of optimal transportation and corresponds to Rₒₜ described above.

In the example illustrated in FIG. 5, the conversion rule generation section 202 generates embedded representations with respect to each attribute name included in the attribute set A^{s} associated with the source data set D^{s} and each attribute name included in the attribute set A^{t} associated with the target data set D^{t}. More specifically, the conversion rule generation section 202 embeds, in an n-dimensional Euclidean space SP1, each attribute name included in the attribute set A^{s} and each attribute name included in the attribute set A^{t}. n may be set to, for example, about 300.

In the Euclidean space SP1, words (attribute names) similar to each other are embedded in positions close to each other. A^{s} such, “toy” and “toy shop” are embedded in respective positions close to each other, and “motorcycle article”, “motorcycle shop”, and “car part” are embedded in respective positions close to each other. Such embedded representations can be generated, for example, by fasttext or the like.

Next, the conversion rule generation section 202 calculates World Rotator's Distance with respect to the embedded representations, and uses an optimal transport matrix T thereof as a matrix R. The matrix R is a matrix that indicates a similarity between attributes with use of a numerical value ranging from 0 to 1. Note that the closer to 1, the higher the similarity. For example, in the matrix R illustrated in FIG. 5, the value for a combination of attributes similar in concept, such as “motorcycle article” and “motorcycle shop”, is 1. In contrast, the value for a combination of attributes not similar in concept, such as “motorcycle article” and “toy shop”, is 0. The matrix R as described above is stored in the storage section 21 as the conversion rule 212.

A^{s} in the example illustrated in FIG. 5, the matrix R generated in accordance with the theory of optimal transport tends to have 1 for a combination of concepts similar to each other and have 0 for a combination of concepts not similar to each other, and less likely to have an intermediate numerical value. Thus, in a case of generating a conversion rule on the basis of the theory of optimal transport, it is easy to understand the relationship between an attribute of the source data set D^{s} and an attribute of the target data set D^{t}. That is, using the optimal transport matrix as the conversion rule 212 is advantageous in that the ultimate result of categorization is more explicable and interpretable, as described above. In contrast, in a case where, for example, a cosine similarity (R_{cos}) or the like is used as the conversion rule 212, many intermediate values between −1 and 1 are outputted. This may lower the explicability and the like in comparison to a case in which an optimal transport matrix is used.

### (Specific Example of Conversion)

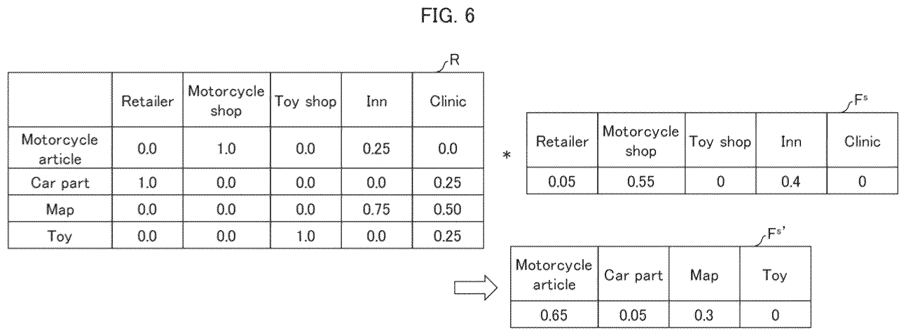

FIG. 6 is a diagram illustrating an example of conversion of a feature with use of the matrix R illustrated in FIG. 5. A^{s} illustrated in FIG. 6, calculating a matrix product of the matrix R and the feature vector F^{s} allows the feature vector F^{s} to be converted into a feature vector F^{s}′ of an attribute of the target data set D^{t}.

Specifically, the score “0.05” of “retailer” in the feature vector F^{s} is converted in accordance with the matrix R into a score “0.05” of “car part”. The score “0.55” of “motorcycle shop” is converted in accordance with the matrix R into a score of “motorcycle article” (0.55). The score “0.4” of “inn” is converted in accordance with the matrix R into a score of “motorcycle article” (0.1). Thus, the score of “motorcycle article” in the feature vector F^{s}′ is “0.65”.

The feature vector F^{s} indicates that a user (a user having a user ID “u01_s” in FIG. 4) corresponding to the feature vector F^{s} has used a credit card for “retailer”, “motorcycle shop”, and “inn” in a ratio of 0.05, 0.55, and 0.4.

The feature vector F^{s}′ indicates an inference result that the user is interested in “motorcycle article”, “car part”, and “map” in a ratio of 0.65, 0.05, and 0.3 on the online shopping site.

A^{s} described above, the feature calculation section 201 can calculate a score indicative of a degree to which data included in the source data set D^{s} falls under an attribute associated with the source data set D^{S}. The conversion section 203 can apply the conversion rule 212, which is generated on the basis of a relationship between attributes of the target data set D^{t} and attributes of the source data set D^{s}, to convert a score of the source data set D^{s} into a score indicative of a degree to which data included in the source data set D^{S} falls under an attribute of the target data set D^{t}.

According to the above configuration, a score of the source data set D^{S} is converted into a score indicative of a degree to which data included in the source data set D^{s} falls under an attribute of the target data set D^{t}. A^{s} such, it is possible to easily extract similar data from across the target data set D^{t} and the source data set D^{s} on the basis of the magnitude of the value of that score. It is also possible to easily explain and interpret the reason for the extraction on the basis of the magnitude of the value of the score.

### (Specific Example of Extraction of Similar Data)

The similar data extraction section 204 extracts, from among the plurality of pieces of data included in the target data set D^{t}, similar data similar to data included in the source data set D^{s}. In order to extract the similar data, a map such as g below may be configured. The map g converts a set U^{s} of users included in a given source data set D^{s} into a subset 2^{Ut} of a set U^{t} of users included in the target data set D^{t}, and convers an element u included in the source data set D^{s} into an element C included in the set of the users U^{t}. It can be said that the map g returns a data group of the target data set D^{t} which data group is similar to data of the source data set D^{s}.

$$g : {U}^{s} \to {2}^{{U}^{t}} , u ↦ C ⊂ {U}^{t}$$

For example, the similar data extraction section 204 may generate a union below.

$${\{ ψ ( {ϕ}^{s} ( u ) ) \}}_{u ∈ {U}^{s}} ⋃ {\{ {ϕ}^{t} ( {u}^{′} ) \}}_{{u}^{′} ∈ {U}^{t}}$$

The above union is a union of (i) a set of features ψ(φ^{s}(u)) each obtained by converting a feature φ^{s}(u) pertaining to an attribute associated with the data u of the source data set D^{s} into a feature pertaining to an attribute of the target data set D^{t} and (ii) a set of features φ^{t}(u′) each pertaining to an attribute associated with data u′ of the target data set D^{t}.

The similar data extraction section 204 can carry out clustering in this union and extract, as similar data, data u′ included in a cluster to which the data u belongs. Note that the clustering can be carried out by any method, and, for example, the K-Means method, the Ward method, DBSCAN, or the like may be applied.

Further, for example, instead of carrying out the extraction of similar data all at once as described above, the similar data extraction section 204 can carry out clustering with respect to

$${\{ {ϕ}^{t} ( {u}^{′} ) \}}_{{u}^{′} ∈ {U}^{t}} ,$$

which is a set of features φ^{t}(u′) each pertaining to an attribute associated with data u′ of the target data set. In this case, the similar data extraction section 204 can determine to which cluster the data φ^{s}(u) of the source data set D^{s} belongs. With this method, the data of the source data set D^{s} always belongs to the same cluster as any of the target data set D^{t}.

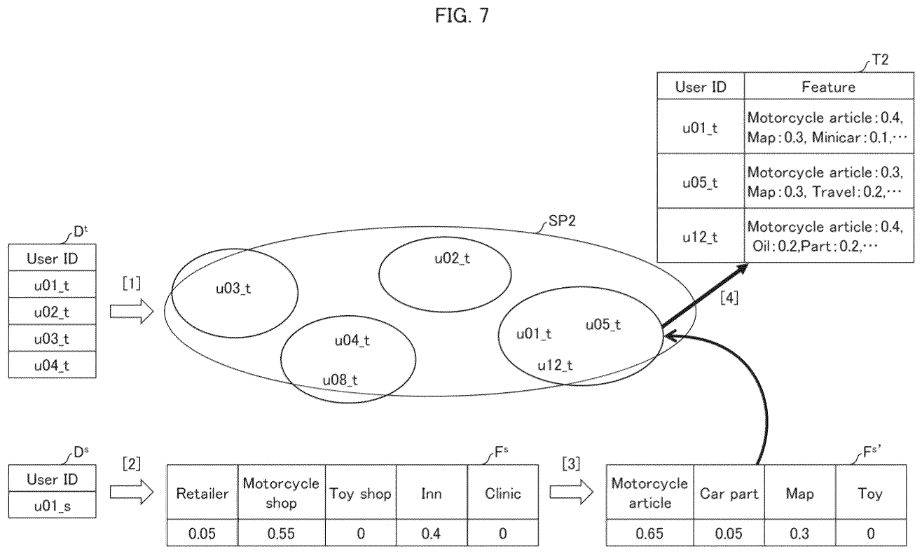

FIG. 7 illustrates an example of application of this method. FIG. 7 is a diagram illustrating an example of extraction of similar data. In this example of extraction, first, for each user included in the target data set D^{t}, a feature vector on the basis of corresponding attributes (specifically, “motorcycle article” to “toy”) is calculated by the feature calculation section 201. Then, the similar data extraction section 204 carries out clustering of the users in a feature space SP2 on the basis of calculated feature vectors thus calculated, as indicated in [1] in FIG. 7.

For a user (a user having a user ID “u01_s”) included in the source data set D^{s}, the feature calculation section 201 generates a feature vector F^{s} on the basis of corresponding attributes (specifically, “retailer” to “clinic”), as indicated in [2] in FIG. 7. Further, as indicated in [3] in FIG. 7, the feature vector F^{s} is converted into a feature vector F^{s}′ by the conversion section 203.

Note here that the feature vector F^{s}′ is expressed with use of attributes of the target data set D^{t} and can therefore be classified into any of the clusters in the feature space SP2 generated in the above-described process of [1].

Then, the similar data extraction section 204 extracts, as users who are similar to the user included in the source data set D^{s}, users included in the cluster to which the feature vector F^{s}′ belongs. In the example illustrated in FIG. 7, three users having respective user IDs “u01_t”, “u05_t”, and “u012_t” are extracted as indicated in [4] in FIG. 7. The scores of the features of these users are values similar to one another, as indicated in Table T2 in FIG. 7. Further, the scores are values also similar to the feature vector F^{s}′ of the user of the source data set D^{s}.

Note that, in a case where the data indicates a user as in the example above, similar users may be extracted by applying an audience expansion technique. The process of the audience expansion technique is similar to clustering, in that the process assigns a score to each user, rearranges the users in descending order of the score, and returns the highly ranked user as a similar user. Details of the audience expansion technique are described, for example, in the literature below.

Stephanie deWet et al., “Finding Users Who Act Alike: Transfer Learning for Expanding Advertiser Audiences”, July 2019, Proceedings of the 25th ACM SIGKDD International Conference on Knowledge Discovery &, Data Mining, pp. 2251-2259

### (Flow of Information Processing Method: Preparation Stage)

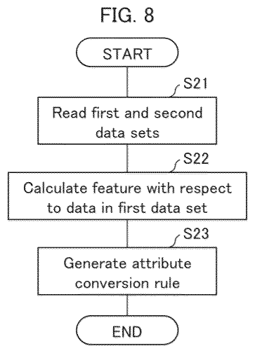

A flow of an information processing method carried out by the information processing apparatus 2 will be described with reference to FIG. 8. FIG. 8 is a flowchart illustrating a flow of a process carried out by the information processing apparatus 2 at a preparation stage before carrying out conversion of a feature and extraction of similar data.

A^{t} S21, the information processing apparatus 2 carries out reading of the first and second data sets. The first and second data sets are inputted via, for example, the input section 22 and stored in the storage section 21 as a data set 21.

The first data set includes a plurality of pieces of data, and a first attribute expressed in a natural language is associated with the first data set. The first data set corresponds to the target data set described above. The first attribute may or may not be indicated in the first data set. In the latter case, apart from the first data set, data (for example, data such as the above-described associated data M^{t}) indicative of the first attribute may be read.

With the second data set, a second attribute expressed in a natural language and different from the first attribute is associated. The second data set corresponds to the source data set described above. Since only the attribute of the second data set is used in the preparation stage, the data themselves of the second data set do not need to be read at S21. A^{t} S21, for the second data set, data (for example, data such as the above-described associated data M^{s}) indicative of the second attribute may be read.

A^{t} S22, the feature calculation section 201 calculates, with respect to each piece of data of the first data set read at S21, a feature pertaining to the first attribute. For example, the feature calculation section 201 may calculate the feature vector F^{t} as illustrated in FIG. 4.

A^{t} S23, the conversion section 203 generates a conversion rule for converting the second feature pertaining to the second attribute in the second data set read at S21 into a first feature pertaining to the first attribute in the first data set which is also read at S21. For example, the conversion section 203 may generate the matrix R illustrated in FIG. 5 as a conversion rule. The generated conversion rule is stored in the storage section 21 as the conversion rule 212. Thus, the process in the preparation stage ends. Note that the processes S22 and S23 may be carried out simultaneously, or S23 may be carried out first.

### (Flow of Information Processing Method: Inference Stage)

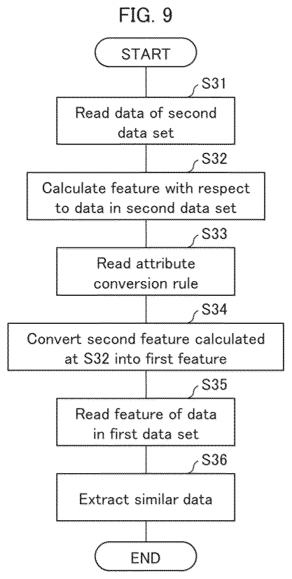

FIG. 9 is a flowchart illustrating a flow of an information processing method carried out after the above-described process in the preparation stage. In the flow illustrated in FIG. 9, a conversion with use of the conversion rule 212 generated in the preparation stage is carried out, and then extraction (inference) of similar data is carried out.

A^{t} S31, the information processing apparatus 2 reads data of the second data set. The data is inputted via, for example, the input section 22 and stored in the storage section 21 as a data set 21. A^{t} S31, at least one piece of data included in the second data set may be read. In a case where reading of the data of the second data set is also completed at S21 in FIG. 8, the process in S31 is omitted.

A^{t} S32, the feature calculation section 201 calculates, with respect to the data of the second data set read at S31, a second feature pertaining to the second attribute. For example, the feature calculation section 201 may calculate the feature vector F^{s} as illustrated in FIG. 4.

A^{t} S33, the conversion section 203 reads the conversion rule 212 generated at S23 in FIG. 8. Then, at S34, the conversion section 203 uses the conversion rule 212 read at S33 to convert the second feature calculated at S32 into a first feature pertaining to the first attribute. For example, as in the example illustrated in FIG. 6, the conversion section 203 may integrate the matrix R, which is the conversion rule 212, and the feature vector Fs, which is the second feature, into a feature vector Fs' which is the first feature.

A^{t} S35, the similar data extraction section 204 reads the feature calculated at S22 in FIG. 8, i.e., the feature pertaining to the first attribute of each piece of data included in the first data set. Then, at S36, the similar data extraction section 204 extracts, on the basis of the feature read at S35 and the first feature generated by the conversion at S34, similar data similar to the data included in the second data set, from among the plurality of pieces of data included in the first data set. The similar data extraction section 204 stores the extracted data as result data 213 in the storage section 21.

Thus, the process of FIG. 9 ends. By changing the data read at S31, it is possible to extract similar data from the first data set for each piece of data included in the second data set. Note that the processes S31, S33, and S35 may be carried out simultaneously, or the order in which these processes are carried out may be changed as appropriate.

### [Variation]

In the example embodiments described above, an example case has been described in which features after conversion are used to extract similar data and the extracted similar data are stored as result data 213. However, the features after conversion may be used for any purposes, not confined to the one in this example.

For example, after similar data are extracted with use of features after conversion, a feature image may be generated in which characteristics of features of the extracted similar data are visualized. This will be described with reference to FIG. 10. FIG. 10 is a diagram illustrating an example of generation of a feature image in which characteristics of features of similar data are visualized.

In the example illustrated in FIG. 10, a feature image IMG is generated from features of the three users indicated in the table T2 illustrated in FIG. 7. The feature image IMG can be generated by calculating an average value of the values of each attribute of the three users and drawing a character string of the attribute in accordance with the magnitude of the value. For example, such a feature image can be generated by using WordCloud.

Such a feature image can also be generated with respect to features after conversion. For example, it is possible to generate a feature image from features after conversion with respect to data of the source data set, generate a feature image from features of data of the target data set, and store those feature images as result data 213. In this case, a relationship between the data of the target data set and the data of the source data set is expressed by the feature image. Note that, in this case, a single piece of data of the target data set and a single piece of data of the source data set may be used.

### Application Example

The information processing apparatus 2 described above can be used in a variety of applications. For example, the information processing apparatus 2 can extract, with use of a source data set of a certain user A, a similar user who is similar to the user A from among a plurality of users corresponding to respective pieces of data included in the target data set.

Note here that the information processing apparatus 2 can obtain data pertaining to the similar user from among the data included in the target data set. For example, in a case where the target data set indicates a history of purchases of an online shopping site, the information processing apparatus 2 can obtain data indicative of a product purchased by the similar user.

Then, the information processing apparatus 2 can present, to the user A, information (e.g., an advertisement) that recommends purchasing of a product indicated by the obtained data. For example, in a case where the source data set indicates a history of credit card transactions, the information processing apparatus 2 may cause an advertisement to be displayed, for example, on the user's personal account webpage of the credit card company. In this case, even if the user A has not used the online shopping site at all, it is possible to explain, on the basis of an attribute of the source data set, the reason why the purchasing of the product is recommended.

Further, according to the information processing apparatus 2, for example, a source data set indicative of a history of credit card transactions at a certain shop can be used to analyze what attribute the user who has shopped at the shop will react to on an online shopping site. In other words, according to the information processing apparatus 2, it is possible to analyze what product attribute on the online shopping site will have a high score. Such an analysis result is useful for, for example, deciding on a product to be sold at a shop.

The information processing apparatus 2 can also be used in various analyses across industries. Assume, for example, that a company A in the clothing retailer industry is considering entering the car industry, which is another industry. In this case, for example, data pertaining to business partners of the company A can be used as a source data set, and data pertaining to business partners of a company B which sells car articles and to products handled by the company B can be used as a target data set. The attributes of the target data set may be categories of the handled products. In this case, the information processing apparatus 2 can extract business partners of the company B that are similar to the business partners of the company A.

Note here that the attributes of the extracted business partners of the company B indicate the categories for the handled products of the business partners. Of these attributes, those with a high score can be said to be highly associated with both the clothing and car industries. For example, in a case where, as a result of carrying out the analysis described above, a score of an attribute “seat” is high, the information processing apparatus 2 may determine that a handled product to be recommended to the company A is a seat for vehicles. Based on this recommendation, the company A can ask its business partners to manufacture a seat for vehicles. Thus, the information processing apparatus 2 can also be used in various analyses across industries.

### [Variation]

The processes described in the example embodiments above may be carried out by any entity, not confined to the above-described examples. That is, an information processing system having functions similar to those of the information processing apparatus 1 or 2 can be constructed by a plurality of apparatuses capable of communicating with each other. Further, the processes described in the example embodiments described above may be realized, for example, in a form such as “software as a service” (SaaS).

### [Software Implementation Example]

Some or all of the functions of the information processing apparatus 1 or 2 may be realized by hardware such as an integrated circuit (IC chip) or may be alternatively realized by software.

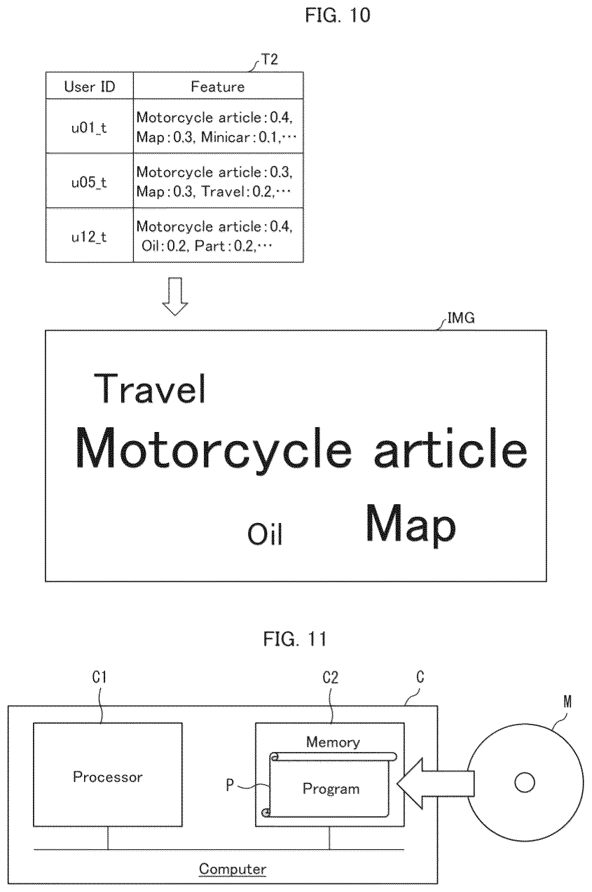

In the latter case, the information processing apparatus 1 or 2 is realized by, for example, a computer that executes instructions of a program that is software realizing the foregoing functions. FIG. 11 illustrates an example of such a computer (hereinafter referred to as a “computer C”). The computer C includes at least one processor C1 and at least one memory C2. In the memory C2, a program P for causing the computer C to operate as the information processing apparatus 1 or 2 is stored. In the computer C, the foregoing functions of the information processing apparatus 1 or 2 can be realized by the processor C1 reading and executing the program P stored in the memory C2.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C can further include an input-output interface for connecting input-output apparatuses such as a keyboard, a mouse, a display, and a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can acquire the program P via the storage medium M. The program P can also be transmitted via a transmission medium. The transmission medium may be, for example, a communication network, a broadcast wave, or the like. The computer C can acquire the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following example aspects.

### (Supplementary Note 1)

An information processing apparatus, including: a feature calculation means that calculates a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and a conversion means that converts the second feature into a first feature pertaining to the first attribute, on the basis of a relationship between the first attribute and the second attribute.

According to the above configuration, it is possible to extract similar data from across different data sets (i.e., the first data set and the second data set) and also to explain and interpret the reason for the extraction.

### (Supplementary Note 2)

The information processing apparatus according to supplementary note 1, wherein: the feature calculation means calculates, as the second feature, a second score indicative of a degree to which the data included in the second data set falls under the second attribute associated with the second data set; and the conversion means (i) converts the second score to a first score by applying a conversion rule generated on the basis of the relationship between the first attribute and the second attribute, the first score being indicative of a degree to which the data falls under the first attribute and (ii) uses the first score as the first feature.

According to the above configuration, the first score indicative of a degree to which the data falls under the first attribute is referred to as the first feature. This makes it possible to easily extract similar data from across the first data set and the second data set on the basis of the magnitude of the value of the first score. It is also possible to easily explain and interpret the reason for the extraction on the basis of the magnitude of the value of the first score.

### (Supplementary Note 3)

The information processing apparatus according to supplementary note 2, further including a conversion rule generation means that generates the conversion rule according to which, the higher a degree of similarity between the first attribute and the second attribute is, the more significantly the second score is reflected to the first score.

According to the above configuration, the conversion rule can be automatically generated. Further, the generated conversion rule is such that the higher a degree of similarity between the first attribute and the second attribute, the more significantly the second score is reflected to the first score. This makes it possible to carry out conversion reasonably in accordance with the degree of similarity between the first attribute and the second attribute.

### (Supplementary Note 4)

The information processing apparatus according to supplementary note 2, further including a conversion rule generation means that generates the conversion rule from the first attribute and the second attribute in accordance with the theory of optimal transport.

According to the above configuration, the conversion rule can be automatically generated. Further, since the conversion rule is generated in accordance with the theory of optimal transport, the strength of the relationship between the first attribute and the second attribute can be emphasized, so that interpretability and explicability can be further enhanced.

### (Supplementary Note 5)

The information processing apparatus according to any one of supplementary notes 1 to 4, further including a similar data extraction means that extracts similar data which is similar to the data included in the second data set, from among the plurality of pieces of data included in the first data set on the basis of (i) the first feature generated by the conversion by the conversion means and pertaining to the data included in the second data set and (ii) a feature pertaining to the first attribute of the plurality of pieces of data included in the first data set.

According to the above configuration, data similar to data included in the first data set can be automatically extracted from among the plurality of pieces of data included in the second data set.

### (Supplementary Note 6)

An information processing method, including: calculating, by at least one processor, a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and converting, by the at least one processor, the second feature into a first feature pertaining to the first attribute, on the basis of a relationship between the first attribute and the second attribute.

According to the information processing method, it is possible to extract similar data from across different data sets (i.e., the first data set and the second data set) and also to explain and interpret the reason for the extraction.

### (Supplementary Note 7)

A program for causing a computer to function as: a feature calculation means that calculates a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and a conversion means that converts the second feature into a first feature pertaining to the first attribute, on the basis of a relationship between the first attribute and the second attribute.

According to the above program, it is possible to extract similar data from across different data sets (i.e., the first data set and the second data set) and also to explain and interpret the reason for the extraction.

### [Additional Remark 3]

Further, the whole or part of the example embodiments disclosed above can also be expressed as below. An information processing apparatus, including at least one processor, the at least one processor carrying out: a feature calculation process of calculating a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and a conversion process of converting the second feature into a first feature pertaining to the first attribute, on the basis of a relationship between the first attribute and the second attribute.

Note that the information processing apparatus may further include a memory, which may store a program for causing the at least one processor to carry out the feature calculation process and the conversion process. The program may be stored in a computer-readable non-transitory tangible storage medium.

### REFERENCE SIGNS LIST

1: information processing apparatus
11: feature value calculation section
12: conversion section
2: information processing apparatus
201: feature calculation section
202: conversion rule generation section
203: conversion section
204: similar data extraction section
211: data set (first data set, second data set)
212: conversion rule

What is claimed is:

1. An information processing apparatus, comprising at least one processor, the at least one processor carrying out:
a feature calculation process of calculating a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and
a conversion process of converting the second feature into a first feature pertaining to the first attribute, on the basis of a relationship between the first attribute and the second attribute.

2. The information processing apparatus according to claim 1, wherein:
in the feature calculation process, the at least one processor calculates, as the second feature, a second score indicative of a degree to which the data included in the second data set falls under the second attribute associated with the second data set; and
in the conversion process, the at least one processor (i) converts the second score to a first score by applying a conversion rule generated on the basis of the relationship between the first attribute and the second attribute, the first score being indicative of a degree to which the data falls under the first attribute and (ii) uses the first score as the first feature.

3. The information processing apparatus according to claim 2, wherein the at least one processor carries out a conversion rule generation process of generating the conversion rule according to which, the higher a degree of similarity between the first attribute and the second attribute is, the more significantly the second score is reflected to the first score.

4. The information processing apparatus according to claim 2, wherein the at least one processor carries out a conversion rule generation process of generating the conversion rule from the first attribute and the second attribute in accordance with the theory of optimal transport.

5. The information processing apparatus according to claim 1, wherein the at least one processor carries out a similar data extraction process of extracting similar data which is similar to the data included in the second data set, from among the plurality of pieces of data included in the first data set on the basis of (i) the first feature generated by the conversion in the conversion process and pertaining to the data included in the second data set and (ii) a feature pertaining to the first attribute of the plurality of pieces of data included in the first data set.

6. An information processing method, comprising:
calculating, by at least one processor, a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and
converting, by the at least one processor, the second feature into a first feature pertaining to the first attribute, on the basis of a relationship between the first attribute and the second attribute.

7. A computer-readable non-transitory storage medium storing a program for causing a computer to function as:
a feature calculation means that calculates a second feature pertaining to a second attribute with respect to data included in a second data set out of (i) a first data set which includes at least one piece of data and with which a first attribute expressed in a natural language is associated and (ii) the second data set which includes a plurality of pieces of data and with which the second attribute expressed in a natural language is associated; and
a conversion means that converts the second feature into a first feature pertaining to the first attribute, on the basis of a relationship between the first attribute and the second attribute.
